(19) United States
(12) Patent Application Publication
(10) Pub. No.: US 2015/0278714 A1
(43) Pub. Date: Oct. 1, 2015

(54) METHODS, SYSTEMS AND PROCESSORS FOR OBTAINING A BOOKING FOR CHILD CARE

(71) Applicant: Kindy Now Pty Ltd, Elwood (AU)

(72) Inventors: Sean COLLINS, Elwood (AU); Matt MAYER, Hong Kong (HK)

(21) Appl. No.: 14/529,613

(22) Filed: Oct. 31, 2014

(30) Foreign Application Priority Data
Mar. 27, 2014 (AU) 2014100302

(51) Int. Cl. G06Q 10/02

(52) U.S. Cl. CPC G06Q 10/02

(57) ABSTRACT

A processor for obtaining a booking for child care starting at a time. The processor includes at least one microprocessor, a memory and a communications interface for providing access to a communications conduit. The memory including instructions executable by the at least one microprocessor such that the processor is operable to: send to a plurality of personal computing devices via the communications interface service availability information indicative of the availability of child care starting at the time; receive from one of the plurality of personal computing devices via the communications interface booking request information indicative of a request for child care starting at the time; and modify booking data stored in at least one of the memory and another memory using the booking request information.

### RELATED APPLICATION

The present application claims priority to Australian Innovation Patent No. 2014100302, filed Mar. 27, 2014, the disclosure of which is hereby incorporated by reference herein in its entirety.

### TECHNICAL FIELD

The disclosure herein generally relates to methods, systems and processors for obtaining a booking for child care.

### BACKGROUND

The management of bookings for child care impact on the child care provider's profitability and/or viability.

Enquiries may fill some or most of the available times for child care. Some available times may be left unfilled. Costs may be incurred if an available time for child care is unfilled (for example staff wages, rental costs, heating or cooling costs, etc.), and consequently unfilled time for child care may represent a period of reduced profitability or loss.

To overcome this problem, a child care provider may phone many people to offer child care during an unfilled booking period. There are generally several problems with this approach, however:
Generally, only a small proportion of people contacted may be interested, and consequently attempting to fill an available time for child care by making phone calls is generally unproductive and expensive.
Soliciting by phone calls may be perceived to be intrusive and/or unprofessional, which may reduce goodwill and reduce success.
The closer an available time is, the less time there is to contact potential clients and customers, and the greater the chance that the potential clients and customers have other engagements. Consequently, available times that are in the near future may be difficult to fill by making phone calls.
If most of the child care provider's time is booked, the child care provider and/or staff may be near fully occupied and thus generally unavailable to make phone calls to fill the available times. Consequently, it may be difficult to fill the last remaining unfilled service time periods.

Providing better methods, systems and processors for filling available times for child care, especially a time slot that is in the near future, may be advantageous.

### SUMMARY

Disclosed herein is a method for obtaining a booking for child care starting at a time. The method comprises the step of a processor sending to a plurality of personal computing devices child care availability information indicative of the availability of child care starting at the time. The method comprises the step of the processor receiving booking request information from one of the plurality of personal computing devices, the booking request information being indicative of a request for child care starting at the time, the processor subsequently modifying booking data stored in memory using the booking request information.

In an embodiment, the booking for child care is for child care at a child care center. The booking request information may be indicative of a request for child care at the child care center. The processor may subsequently modify child care center booking data stored in memory using the booking request information without child care center representative input to indicate that a user of the one of the plurality of personal computing devices has booked child care at the child care center starting at the time.

Filling a time period may be automated. Embodiments may reduce the difficulty of filing available times, especially available times in the near future. Clients and customers may be able to remotely book for child care at “the last minute”. Booking may be made anywhere and anytime, especially in examples wherein the plurality of personal computing devices comprise a smart phone and/or a tablet computer.

In an embodiment, the booking request information is generated by the user interacting with the one of the plurality of personal communication devices. Each of the plurality of personal communication devices may have a user interface for the user to interact with, and an application that configures the user interface. The interface may be configured to display child care availability information. The booking information may be sent by the one of the plurality of personal computing devices to the processor via a communications conduit. The communications conduit may comprise a network. The network may comprise the Internet. The processor sending and receiving may be via a communications interface of the processor that provides access to the communications conduit. The communications interface may comprise a network interface.

In an embodiment, the processor sends to the plurality of personal computing devices child care availability information no earlier than a predetermined time. The predetermined time may be within one week of the time the child care starts. The predetermined time may be within 3 days of the time the child care starts. The predetermined time may be within 24 hours of the time the child care starts. The predetermined time may be within 1 hour of the time the child care starts.

In an embodiment, child care availability information comprises incentive information indicative of an incentive for making a request for child care to start at a child care provider preferred time.

In an embodiment, the processor provides an incentive for the receipt of the booking request information.

In an embodiment, the step of the processor modifying booking data stored in memory comprises the step of the processor subsequently modifying booking data stored in a memory of the processor or another memory. The processor may be in communication with another processor and the other memory may be that of the other processor. The processor and the other processor may be in communication via an application program interface (API). The other processor may have program instructions for child care management. The API may be defined by child care management program instructions. The API may define hyper text transfer protocol requests. The API may define the transfer of information in Java Script Object Notation (JSON) format.

In an embodiment, the plurality of personal computing devices may be associated with a plurality of children. The plurality of children may be registered with a provider of the child care. The processor may select the plurality of children from registered child data stored in a memory. The processor may select the plurality of children using a child selection module. The processor may select the plurality of children using a selection rule. The registered child care data may be indicative of another plurality of children registered with the provider of the child care.

Child care availability information may only be sent to the plurality of computing devices of appropriate users. For example only parents with a child that is the right age for child care starting at the times, or parents that have expressed an interest generally for the start time.

Disclosed herein is a method for obtaining a booking for child care starting at a time. The method comprises the step of each of a plurality of personal computing devices receiving from a processor child care availability information indicative of the availability of child care starting at the time, the child care availability information being for display on a plurality of electronic displays of the plurality of personal computing devices. The method comprises the step of a user interacting with one of the plurality of personal computing devices to generate booking request information indicative of a request for child care starting at the time, and the one of the plurality of personal computing devices subsequently sending the booking request information to the processor.

An embodiment comprises the step of the booking request information being sent to the processor for the processor to modify booking data stored in memory using the booking request information.

In an embodiment, the processor may be in communication with another processor and may modify booking data stored in a memory of the other processor. The processor and the other processor may be in communication via an application program interface (API). The other processor may have program instructions for management of child care. The API may be defined by child care management program instructions. The API may define hyper text transfer protocol requests. The API may define the transfer of information in JSON format.

An embodiment comprises the step of an application on each of the plurality of personal computing devices and the one of the plurality of personal communication devices configuring a user interface. The user may interact with the user interface of the one of the plurality of personal computing devices.

In an embodiment, the booking request information may be sent, and child care availability information may be received, via a communications conduit. The communications conduit may comprise a network. The network may comprise the Internet. The processor sending and receiving may be via a communications interface of the processor that provides access to the communications conduit. The communications interface may comprise a network interface.

In an embodiment, each of the plurality of personal computing devices receive from the processor child care availability information no earlier than a predetermined time. The predetermined time may be within one week of the time child care starts. The predetermined time may be within 3 days of the time child care starts. The predetermined time may be within 24 hours of the time child care starts. The predetermined time interval may be within 1 hour of the time child care starts.

In an embodiment, child care availability information comprises incentive information indicative of an incentive for making a request for child care to start at a child care provider preferred time.

In an embodiment, the processor provides an incentive for the receipt of the booking request information.

In an embodiment, child care may comprise child care at a child care center. Generally, but not necessarily, the plurality of personal computing devices are associated with a plurality of children. The plurality of children may be registered with the provider of the child care. The processor may select the plurality of children from registered child data stored in a memory. The processor may select the plurality of children using a child selection rule. The registered child care data may be indicative of another plurality of children registered with the provider of the child care. The selection of the plurality of children may be by a selection module of the processor.

In an embodiment, the booking request information may be sent to the processor for the processor to modify child care booking data stored in memory using the booking request information.

Disclosed herein is a processor for obtaining a booking for child care starting at a time, the processor comprising at least one microprocessor, a memory and a communications interface for providing access to a communications conduit, the memory including instructions executable by the at least one microprocessor such that the processor is operable to:

send to a plurality of personal computing devices via the communications interface service availability information indicative of the availability of child care starting at the time;

receive from one of the plurality of personal computing devices via the communications interface booking request information indicative of a request for child care starting at the time; and

modify booking data stored in at least one of the memory and another memory using the booking request information.

In an embodiment, the booking for child care is for a booking for child care at a child care center. Modifying booking data may comprise modifying child care center booking data stored in at least one of the memory and the other memory using the booking request information without child care center representative input to indicate that a user of the one of the plurality of personal computing devices has booked child care at the child care center starting at the time.

In an embodiment, the processor is operable to send to the plurality of personal computing devices child care availability information no earlier than a predetermined time. The predetermined time may be within one week of the time child care starts. The predetermined time may be within 3 days of the time child care starts. The predetermined time may be within 24 hours of the time child care starts. The predetermined time interval may be within 1 hour of the time child care starts.

In an embodiment, child care availability information comprises incentive information indicative of an incentive for making a request for child care to start at child care provider preferred time.

In an embodiment, the processor is operable to provide an incentive for the receipt of the booking request information. The incentive may be for the receipt of the booking request information from a personal computing device.

In an embodiment, the processor is operable to be in communication with another processor and the other memory may be that of the other processor. The processor may be operable to be in communication with the other processor via an application program interface (API). The other processor may have program instructions for service management. The API may be defined by child care management program instructions. The API may define hyper text transfer protocol requests. The API may define the transfer of information in JSON format.

Generally, but not necessarily, the plurality of personal computing devices are associated with a plurality of children. The plurality of children may be registered with the provider of the child care. The processor may be operable to select the plurality of children from registered child data stored in at least one of the memory and another memory. The processor may have a child selection module for the selection of the plurality of children. The processor may select the plurality of children using a child selection rule. The registered child care data may be indicative of another plurality of children registered with the provider of the child care.

In an embodiment, the communications interface is a network interface. The communications conduit may comprise a network. The network may comprise the interne.

Each of the plurality of personal communication devices may have a user interface and an application for configuring a user interface for an associated user to interact with.

Disclosed herein is a system for obtaining a booking for child care starting at a time. The system comprises a plurality of personal computing devices, the plurality of personal computing devices each being arranged to receive from a processor service availability information indicative of the availability of child care starting at the time, and each of the plurality of personal computing devices are further arranged to display child care availability information on an electronic display thereof, wherein each of the plurality of personal computing devices are arranged for an associated user interacting therewith to generate booking request information indicative of a request for child care starting at the time, and subsequently send the booking request information to the processor.

In an embodiment, the booking for child care is for child care at a child care center.

An embodiment comprises the processor. The processor may be arranged to send to the plurality of personal computing devices child care availability information no earlier than a predetermined time. The predetermined time may be within one week of the time child care starts. The predetermined time may be within 3 days of the time child care starts. The predetermined time may be within 24 hours of the time child care starts. The predetermined time interval may be within 1 hour of the time child care starts.

In an embodiment, the processor is arranged to modify booking data stored in a memory using the booking request information. The processor may be in communication with another processor and the memory may be that of the other processor. The processor and the other processor may be in communication via an application program interface (API). The other processor may have program instructions for child care management. The API may be defined by the child care management program instructions. The API may define hyper text transfer protocol requests. The API may define the transfer of information in JSON format.

In an embodiment, the personal computing device and the processor are arranged to communicate with each other over a communications conduit. The communications conduit may comprise a network. The network may comprise the internet. The processor may comprise a communications interface. The communications interface may comprise a network interface.

Each of the plurality of personal communication devices may have a user interface and an application for configuring the user interface for an associated user to interact therewith.

In an embodiment, the child care availability information comprises incentive information indicative of an incentive for making a request for child care to start at child care provider preferred time.

Generally, but not necessarily, the plurality of personal computing devices are associated with a plurality of children. The plurality of children may be registered with a provider of the child care. The processor may be arranged to select the plurality of children from registered child data stored in at least one of the memory and the other memory. The processor may have a child selection module for the selection of the plurality of children. The registered child care data may be indicative of another plurality of children registered with the provider of the child care. The processor may be arranged to update child care booking data stored in at least one of the memory and the other memory using the booking request information.

Disclosed herein is a processor readable tangible media including program instructions which when executed by a processor causes the processor to perform a method disclosed above.

Disclosed herein is a computer program for instructing a processor, which when executed by the processor causes the processor to perform a method disclosed above.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows an embodiment of a processor for obtaining a booking for child care.

FIGS. 2 and 3 show flow charts of embodiments of a method for obtaining child care.

FIGS. 4 to 14 are screen shots of user interfaces on the touch screen of a plurality of personal computing devices.

FIG. 15 shows another embodiment of a processor for obtaining a booking for child care.

FIG. 16 shows information generated by the processor of either one of FIG. 1 and FIG. 15.

### DESCRIPTION OF EMBODIMENTS

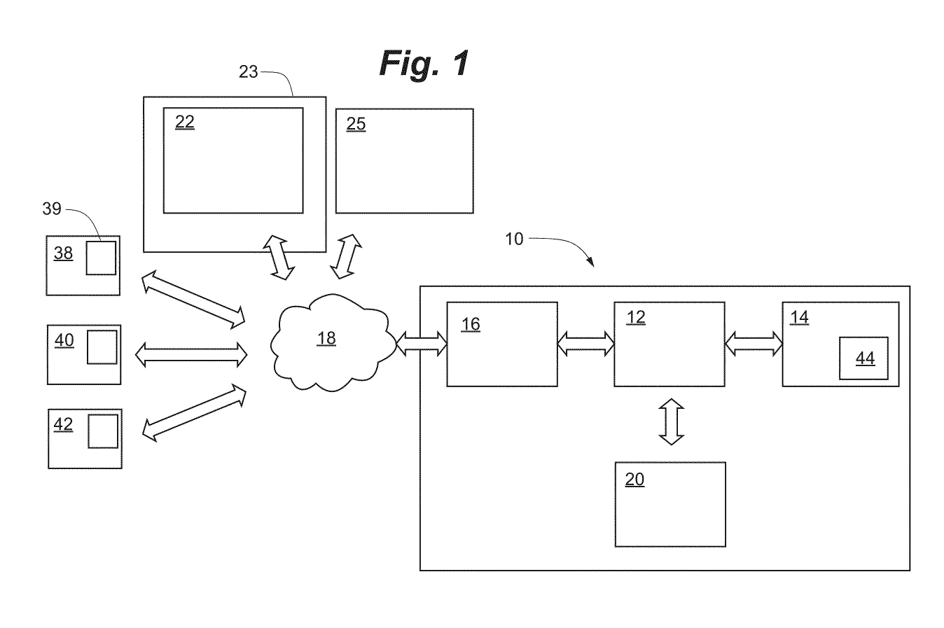

FIG. 1 shows an embodiment of a processor for obtaining a booking for child care starting at a time, the processor being generally indicated by the numeral 10. In this but not necessarily in all embodiments, the booking for child care is a booking for child care at a child care center. The processor 10 has a microprocessor 12, memory 14, and a communications interface 16 for providing access to a communications conduit in the form of a computer network 18. The network 18 in this example the interne 18.

The booking request information may be indicative of a request for child care at the child care center.

A plurality of personal computing devices 38, 40, 42 are each configured to communicate with the processor 10 via the network 18. While three personal computing devices are shown in FIG. 1, there may be less (for example 2) or more (for example one of at least 50, 100 and 500). The plurality of personal computing devices are generally remote of the processor 10 and are operable by a plurality of users to book child care.

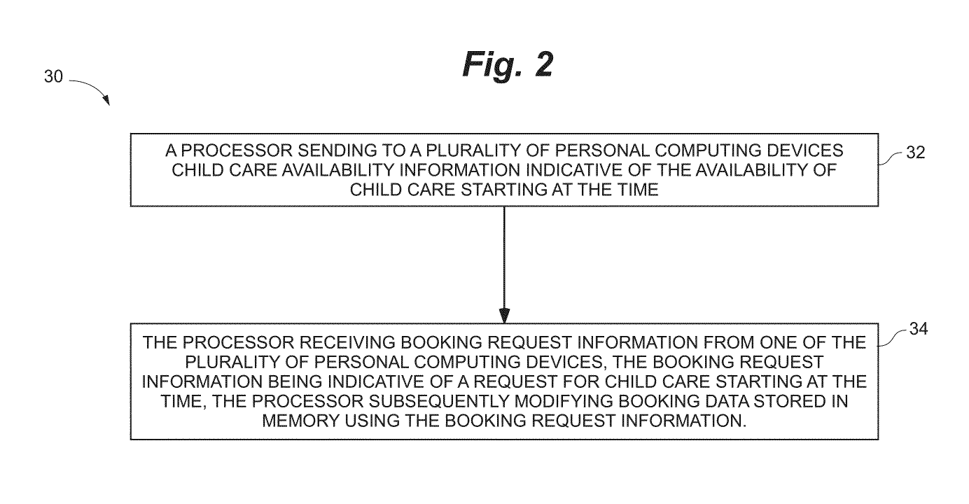

The memory 14 of the processor 10 has instructions executable by the microprocessor 12. When the microprocessor 12 executes the instructions, the processor 10 is operable to perform the steps of an embodiment of a method 30 represented by the flow chart of FIG. 2.

In one step 32 of the embodiment of the method 30, the processor sends to the plurality of personal computing devices 38, 40, 42 child care availability information indicative of the availability of child care starting at a time or during a period. The sent child care availability information is generally but not necessarily for display by the plurality of personal computing devices to a plurality of users thereat. Child care availability data is sent, in this but not necessarily in all embodiments, via the network interface 16. The available time for child care may be, for example, 9 am to 12 pm on a Monday, in which case the start time is 9 am and the period is 9 am to 12 pm on the Monday.

In another step 34 of the embodiment of the method 30, the processor 10 receives booking request information from one of the plurality of personal computing devices 38, 40, 42, the booking request information being indicative of a request for child care starting at the time or during the period of child care. The booking request information is in this embodiment received via a network interface 16, however it may be alternatively received by a point-to-point wired connection or BLUETOOTH™ connection, for example, or generally any suitable connection.

The processor 10 generally subsequently modifies booking data 44 stored in the memory 14 using the booking request information. For example, the modified booking data indicates that a user of the one of the plurality of personal computing devices has booked for child care starting at the time and the identification of the child the child care is for. The processor may modify child care center booking data stored in memory using the booking request information without child care center representative input to indicate that a user of the one of the plurality of personal computing devices has booked child care at the child care center starting at the time.

The processor 10, in this but not necessarily in all embodiments, sends an email to child care provider to notify them that a booking request has been made through it.

In addition to the booking request information from the one of the plurality of personal computing devices 38, 40, 42, further booking request information may be received by the processor from at least one other of the plurality of personal computing devices. The processor may give the first received booking request information priority.

The booking request information may be indicative of the start time or period of the cancelled booking in various ways. For example, the request information may include booking identification information that is used by the processor to look up at least one of the start time and the end time in a table stored in memory. Alternatively, the request information may include time data having at least one of the start time and the end time of the period. Generally the start time or period of the cancelled booking may be indicated in any suitable way.

The booking data 44 may be stored in any one of a number of forms, examples of which include but are not limited to an array of record data structures, a sequence of containers, a doubly linked list of containers, and a database. The instructions in the memory 14 include data base queries to retrieve the relevant records for processing, and field modification instructions to change the data to reflect changes to the bookings and time slots. For example at least one of the user that made the booking, the period of the booking, and the start time of the booking. Generally, the booking data is modified to indicate that the user of the one of the plurality of personal computing devices has booked for the service from the start time of the cancelled booking. The data base may be implemented in any suitable manner, for example by purpose written code in a language such as C++ or PYTHON, or using existing data base software installed on the processor 10. In the present examples, the data base software is a NoSQL database using MongoDB™. Alternatively, the data base software may be SQL or any other suitable type of database. An application program interface may provide access to the database.

In embodiments using a relational data base structure, the relational database structure has a plurality of tables. For example, the data base may have a child details table. The database may have a table for responsible persons. The database may have a table for child care time slots. The database may have a table for the location of the child care (e.g. a room) within the child care center.

In this but not necessarily in all embodiments, the booking data 44 is child care center booking data. The child care center booking data may be indicative of a period in which child care is provided at the child care center. The child care center booking data may be indicative of a plurality of people (i.e., children) booked for child care during the period at the child care center. The child care center booking data may be indicative of a location, for example a room, in which the child care is provided.

There may be a plurality of bookings for a start time by a plurality of users (for example, multiple parents wanting child care starting at the time). The embodiments described herein are applicable to such cases. There may be a plurality of available times, and the plurality of users may be able to select from the plurality of available time.

### Managing a Booking for Child Care

In this example, the processor 10 manages bookings for child care in the form of child care. The users are generally persons who use child care, for example, persons responsible for the plurality of children, such as parents and guardians. In this but not necessarily in all examples, the plurality of children are registered with a child care center 23. The details of the plurality of children are stored in the memory 14, as is personal computing device identification information (for example, a phone number of the personal computing device in the case it is a smart phone and/or the login details entered through a personal computing device). Each child is associated with personal computing device identification information by, for example, putting child details and identification information for a personal computing device in the same data base record or by some other way.

The processor 10 selects the plurality of personal computing devices the child care availability information is sent to, wherein the selected plurality of personal computing devices have a plurality of associated users that satisfy a user selection criteria. The selection of the plurality of personal computing devices may be performed by a personal computing device selection module of the processor. For example, the processor 10 in this but not necessarily in all embodiments executes a child selection rule to select the plurality of children from registered child data stored in the memory 14. The processor 10, 60 has, in these embodiments, a child (or user) selection module for the selection of the plurality of children (or users). The registered child data is indicative of another plurality of children registered with the child care center, for example the other plurality of children may be all of the children registered at the child care center. The selection rule may be, for example “The plurality of children are those in the age group being cared for during the available period”, or “The plurality of children are those that have indicated they are interested in child care on a predetermined day of the week”. Generally any suitable selection rule may be used. The selection rule may take the form of, for example, a query of the database 44 (which in this embodiment includes registered child data), which may take the form of a Boolean expression including field identifiers. The processor may have a child selection module arranged for the selection of the plurality of children. The selected users and their personal computing devices are those associated to the selected plurality of children by the data base.

The processor 10 is, in this embodiment, located remote from the child care provider. Child care provider computing device 22 associated with child care provider 23 is generally, but not necessarily, located at child care provider's premises 23 and is in communication via the network 18 with the processor 10 and operable by a service provider representative, for example a child care provider manager. In alternative embodiments, however, the processor 10 may be located at child care provider's premises, in which case the processor 10 may provide a user interface which may include for example an electronic display, a mouse and keyboard, or generally any suitable user interface. The user interface may be, for example, operated to instruct the child care center computing device 22 to display bookings, view details of user's children registered at the child care center, cancel a booking (including marking a child as absent), etc. The child care center representative may operate the computing device 22.

The user that interacts with the one of the plurality of personal communication devices 38 to generate the booking request information, in this but not all embodiments, is provided with an incentive to do so. The incentive is in the form of a donation to a charity, however any suitable incentive may be provided, for example a payment to the user. The donation or payment may have a value of a few dollars or generally any suitable value. The processor 10 is arranged to credit an account of the user.

### Personal Computing Devices

The personal computing devices 38, 40, 42 may generally be any suitable personal computing device, examples of which include but are not limited to smart phones (for example an APPLE IPHONE or SAMSUNG GALAXY SII), and tablet computers (for example an APPLE IPAD, SAMSUNG GALAXY Tab3). In the example of FIG. 1, the personnel computing devices include at least one of a smartphone (personal computing devices 38 and 40) and a tablet computer (personal computing device 42). Generally, the personal computing devices each have a user interface in the form of a touch sensitive electronic display 39. Other examples may have a keypad and electronic display.

The personal computing devices are configured to connect to the processor 10, 60 via, for example, the communication conduit 18. The connection may include a 3G, 4G, WiFi or other wireless and/or wired network. In this but not necessarily in all embodiments, the personal computing devices are arranged to establish a transport control protocol (TCP) session with the processor 10, 60, and a HTTP session on the TCP layer. Information is generally exchanged between the personal computing devices and the processor 10 using HTTP requests GET and/or POST, with responses from the processor 10, 60 having response information in JSON format. Other protocols, formats, and physical connection types may be used as suitable. For example, UDP or SCTP sessions may be established instead, and proprietary application layer protocols employed.

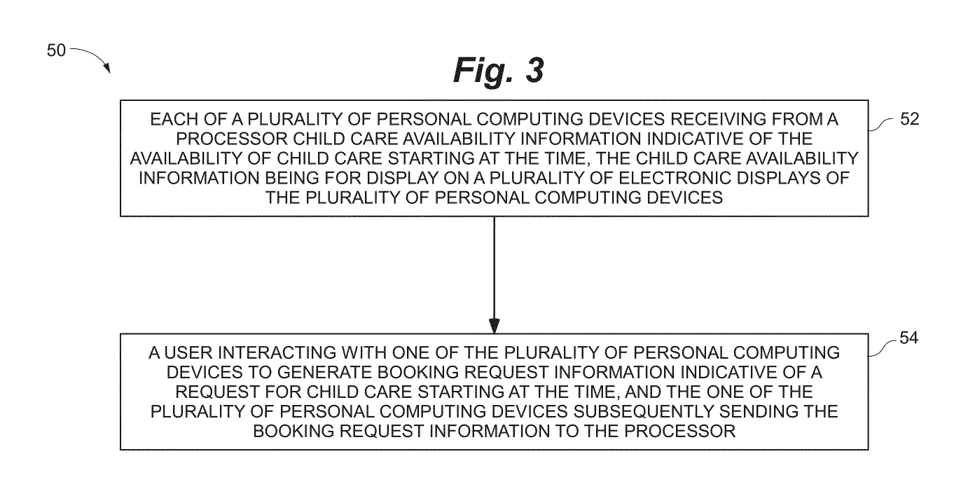

A user of a personal communication device 38, 40, 42 may download and install thereon an application in the form of, for example, an App from, for example, the Apple App or iTunes store, Google Play or any other suitable source. The App may be started by a user of the personal communication device so that the user can interact remotely via the interne or other communication conduit with the processor 10, 60. When the App is running, the personal communication device is configured to take part in the execution of the example methods of FIGS. 2 and 3, for example.

The App may be built using IOS DSK and XCode, Android Studio, Android Software Development Kit “SDK” or APP INVENTOR, by Google Labs, for example, or generally any suitable environment and language.

Using the personal computing devices running the App, an embodiment of a method 50 shown in FIG. 3 may be executed. In one step 52, each of a plurality of personal computing devices 38, 40, 42 receive from the processor 10 child care availability information indicative of the availability of child care starting at the time, child care availability information being for display on a plurality of electronic displays of the plurality of personal computing devices.

In another step 54, a user interacts with one of the plurality of personal computing devices to generate booking request information indicative of a request for child care starting at the time, and the one of the plurality of personal computing devices subsequently sending the booking request information to the processor.

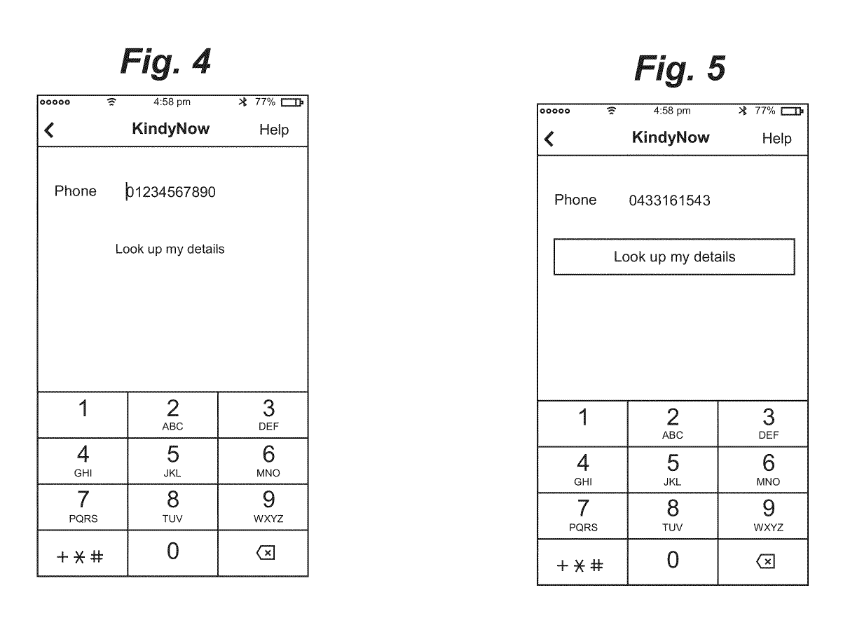

FIGS. 4 to 14 are screen shots of user interfaces in the form of touch screens of each of the plurality of personal computing devices 38, 40, 42 that can be configured by the App. At least some of the images displayed by the user interfaces may be generated during execution of the methods 30 and 50, for example. FIG. 4 shows a displayed keypad that enables the user to sign up by inputting their mobile phone number by touching a plurality of buttons displayed on the touchscreen.

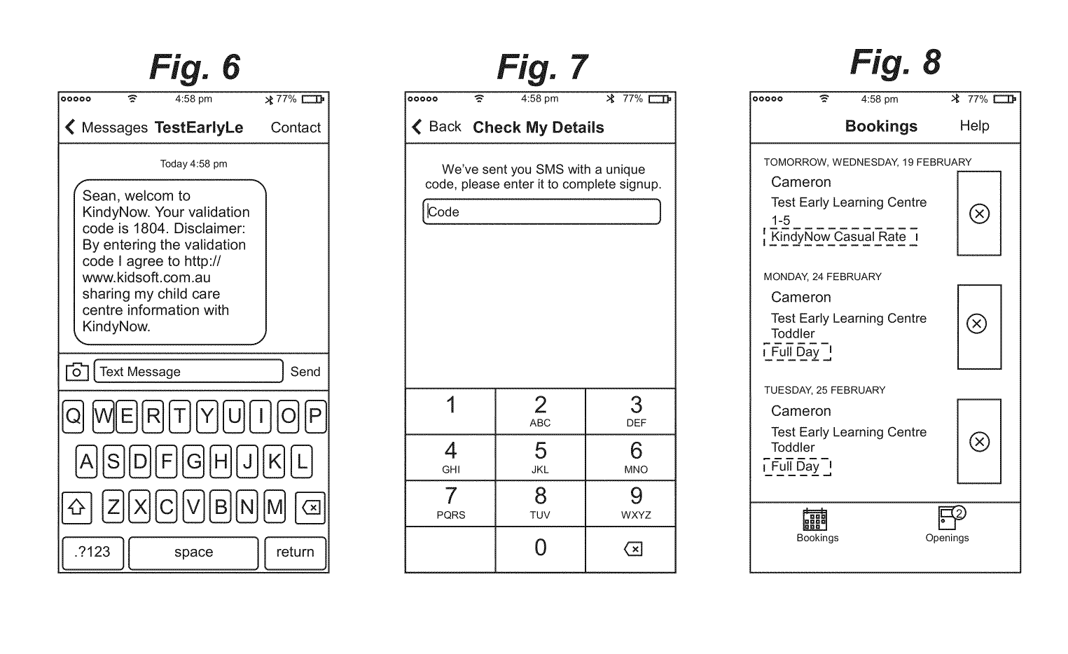

FIG. 5 shows an image displayed on the touch screen after the user enters the mobile phone number, the image confirming the connection between the personal computation device and the processor 10. FIG. 6 shows a user interface showing a validation code received by the personal computing device via SMS or another channel. The user is asked to enter the validation code to share child information with the processor 10. FIG. 7 shows a user interface that enables a user to type in the code to complete the sign up or registration process. FIG. 8 shows a user interface including displayed bookings data held by the processor 10. In this but not all examples, the user can cancel a booking by touching the screen at the position of a displayed cross associated (in this case adjacent) with the booking.

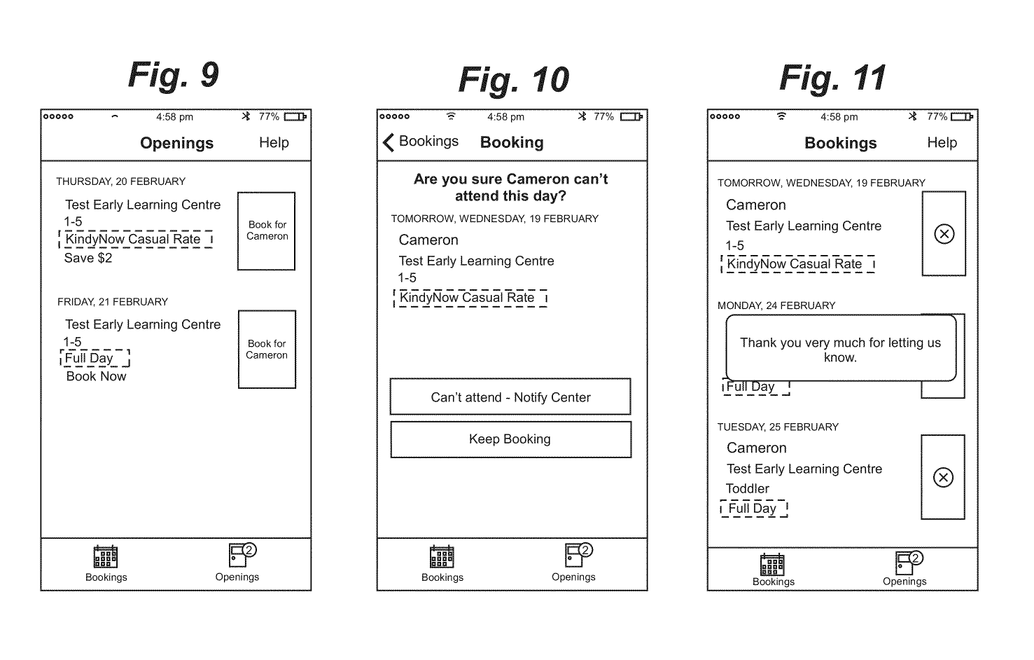

FIG. 10 shows a user interface presented during confirmation of the cancellation. The user can confirm cancelation by pressing a button, in this example, by touching the touchscreen at the displayed text “Can't attend—Notify center”. Alternatively, the user can cancel the cancelation request and so keep the booking by touching the touchscreen at the displayed text “Keep Booking”. FIG. 11 shows a displayed image wherein the personal communication device thanks the user for letting the child care center, via the processor 10, know that the booking is cancelled. The processor 10 then updates the booking data 44. FIG. 9 shows a displayed image including displayed information indicative of available time slots for care of a child at the child care center. In this embodiment, the personal computing device is configured to only display information indicative of available time slots for days without a booking for the child.

Incentives, for example in the form of a financial or other incentive, may be provided, in this example a discount of $2 is offered for a booking on Thursday 20 February. The incentives may, for example, entice a booking on a day on which demand is low, for example, or for which there have been cancellations. In this example, child care availability information comprises incentive information indicative of the incentive for making a booking. For example, the incentive information may indicate which start time has an incentive attached. The incentive information in this but not all embodiments may indicate the value of the incentive. An available time for child care may be more likely to be filled when the incentive is provided. The quantity of incentive may be dependent on the quantity of time to child care start time. For example, an incentive may be provided for booking an available time in the near future (for example, within the predetermined time period). An incentive may not be provided for booking another available time not in the near future. Suitable incentives may include gifts of tangible goods, vouchers for discounts for other services, or generally any other suitable incentive.

In this but not all embodiments, the processor sends to the plurality of personal computing devices child care availability information no earlier than a predetermined time. The predetermined time may be selected in accordance with circumstances. The predetermined time may be within at least one of one week, three days, 24 hours (as is the case in this example), and 1 hour of the time child care starts. However, the predetermined time may be a greater or lesser distance from the time child care starts.

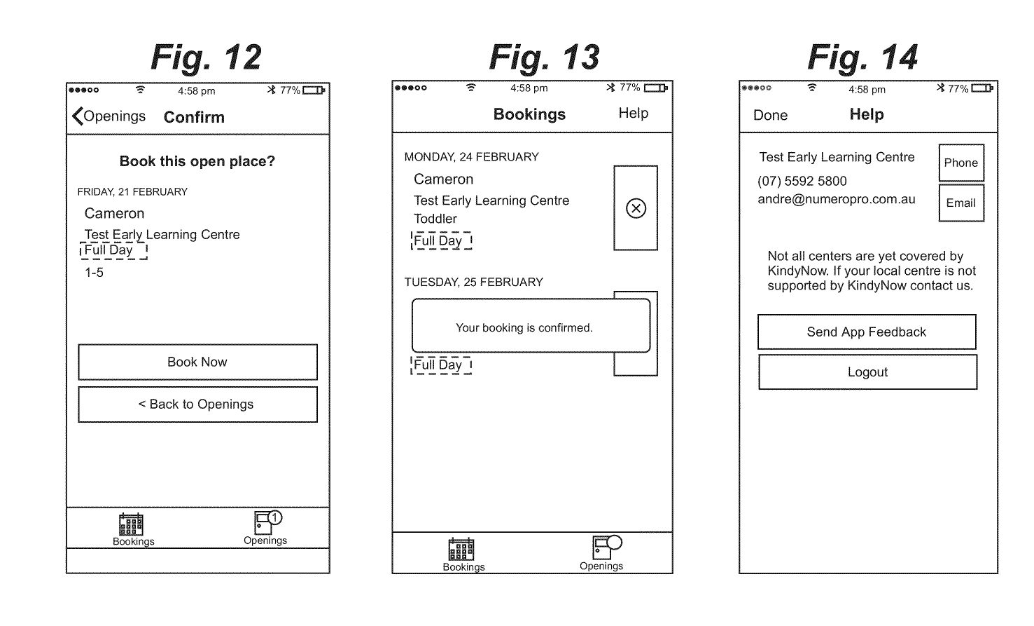

FIG. 12 shows a user interface presented when a user makes a booking at an available time slot. The user may press the “Book Now” button by touching the touchscreen at the text “Book now” to make the booking. FIG. 13 shows a displayed image advising the user that the booking is confirmed. FIG. 14 shows a displayed image of a “help” screen, which includes the user's child care center's phone number and/or email address.

Alternatively, the personal computing device may be a personal computer (for example a personal computer running MICROSOFT WINDOWS or MAC OS), which may be, for example, a desktop or laptop personal computer. The personal computer has a user interface that may include, for example, an electronic display, a keyboard, a mouse and/or a touchpad. The user interfaces may be adjusted for use of these hardware interfaces rather than a touch screen.

### Processor

The processor 10 will now be described in more detail. The processor 10 stores instructions in memory 14. The memory 14 includes nonvolatile memory in the form of at least one of a hard disk drive, solid state memory, FLASH, EPROM or any other form of processor or computer readable tangible media within or external of the processor. The instructions generally, but not necessarily, comprises a plurality of software modules that cooperate when installed on the processor 10 so that the steps of embodiments of the methods may be executed. The software modules, at least in part, correspond to the steps of the method or modules of the systems described above. The functions or components may be compartmentalised into modules or may be fragmented across several software modules. The software modules may be formed using any suitable language, examples of which include C++ and assembly. The modules may comprise a plurality of threads running on the microprocessor 12—which may have more than one core. Inter module communication may be achieved using inter-process communication methods such as file sharing, signalling, sockets, message queues, pipes, memory sharing, message passing, memory-mapped file sharing, or any other suitable method or Application Program Interface. The microprocessor 12 may be any suitable micro processor, for example an INTEL XEON or AMD OPTERON micro processor connected over a bus to a volatile memory component of memory 14 in the form of random access memory of around 10 GB. An alternative embodiment has two or more microprocessors. The processor 10 has input/output interfaces 16 which includes a network interface in the form of a network interface card in this but not necessarily all embodiments, and a universal serial bus. In other embodiments the network interface may be in the form of a USB interface into which is received a USB modem dongle or a WiFi module. The communications interface 16 may comprise at least one of these network interfaces. The processor may support a human machine interface 20 that includes, for example, a mouse and a keyboard in communication with the universal serial bus, and a display in communication with a display port, for example. The processor 10 is in the form of a computer or computer server, examples of which include a Dell PowerEdge™ server and a personal computer.

The instructions executable by the processor 10 are generally in the form of software, but may in some embodiments take the forth of firmware or may be entirely hardware based. The processor may be configured by a single application.

In yet another embodiment, the processor runs two applications that communicate via an Application Program Interface (API). One of the applications may be child care management software, for example existing child care management software “KIDS OFT” running on the processor 10 that provides some child care management functions and is used by child care provider representatives to enter and delete bookings, record child details, and track payments, for example. The other application runs on the same processor 10 and communicates with child care management software via the API and the personal communication devices 38-42 to provide the functionality described herein. Alternatively, the processor may comprise two machines, one having child care management software, the other having the other application communicating with child care management software via an API and a network.

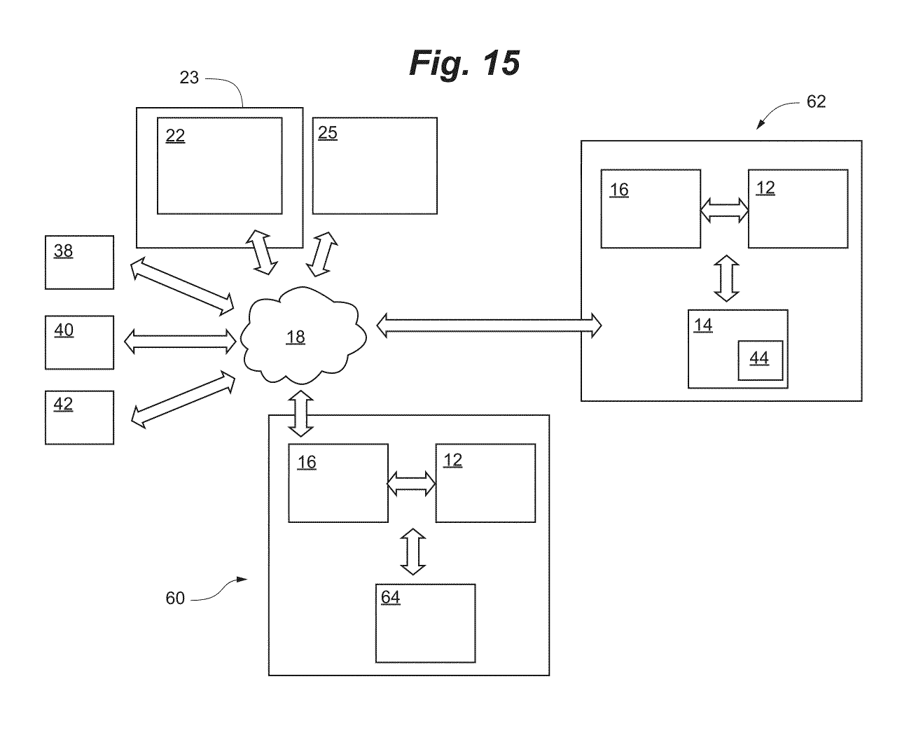

FIG. 15 shows another embodiment of the processor 60, where parts of similar form and/or function to those of FIG. 1 are similarly numbered. The processor 60 comprises a computer server that communicates with the plurality of personal computing devices 38, 40, 42 over the network 18. The processor 60 may be generally located anywhere and comprises a suitably programmed computer server (having the same general architecture as the processor 10, for example), however it may alternatively be a virtual computer server or machine provided by the AMAZON™ Elastic Compute Cloud (Amazon EC2), or generally any suitable computer server.

The processor 60 is arranged to cooperate with another processor 62 in the form of another computer server. The server 60 and other server 62 are in this example operated by different entities and are located in different cities, and communicate via the Internet 18. They may, however, be operated by the same entity and in the same room and communicate via a local network 18. The other processor 62 may also be generally located anywhere and comprises a suitably programmed computer server, however it may alternatively be a virtual computer server. The server 62 has child care management software in the form of, for example, “KIDSOFT”. The processor 60 executes the embodiments of the method of FIG. 2 or variants thereof, as described above. The processor 60 has the structure of processor 10 to perform the variants. The details of clients (parents and children registered with the child care center) are stored in database 44 of memory 14 of the processor 62. The functions of processor 60 may be provided as an optional “plug in” to the existing child care management service provided by child care management software. Thus, the capabilities of the processor 62 may be augmented by processor 60 which provides hitherto unavailable functionality. The processor 60 may cache information received from the data base 44 in memory 64. Cached information may include, for example, registered center information indicative of a plurality of centers from the database 64, registered center phone number information indicative of the phone numbers of the plurality of centers, registered center name information indicative of the names of the plurality of centers, registered center capacity information indicative of the capacity and/or age group for each child care room in each of the plurality of centers (e.g., “red” room is for 1-2 year olds and can hold 10 children, “green” room is for 3-5 year olds and can hold 15 children, etc.), and registered child information indicative of the age and/or name and/or other details of the children registered with each of the plurality of child care centers. The processor 60 may also calculate information from information from the other processor 62 and/or cached in memory 64. For example, the processor 60 may request and receive from the other processor 64 information indicative of the number of children booked for a room at a selected time. Using this information, and cached information on the room capacity; the processor 60 may calculate how many places are available. Incentives to request a booking may be provided if there are a substantial number of free spaces.

In this embodiment, the processor 60 and other processor 62 communicate using an API provided by child care management software, in the form of a hypertext transfer protocol (HTTP) API. A transmission control (TCP) session may be started between the processor 60 and the other processor 62, and on this layer a HTTP session or secure hypertext transfer protocol session (HTTPS) may commence between the processor 60 and other processor 62 (both HTTP and HTTPS are referred herein as HTTP for convenience). The API provided by the child care management software receive commands and requests using a HTTP POST or generally any suitable form of HTTP request. Responses to commands and requests may be sent by child care management software via the API in JSON format over the HTTP session. It will be appreciated that the API may take any suitable form, and may not use HTTP or JSON.

The API becomes active by the processor 60 sending via the HTTP session a security key in the form of a string of symbols to the processor 62 and the processor 62 confirming that the security key is a valid security key.

An example of a session is now described for the embodiment of the system shown in FIG. 15. A user inputs a mobile (or cell) phone number on their personal computing device 38 in communication with the processor 60. The phone number is sent to the processor 60 by the personal computing device. The processor 60 sends a request via the API to the other processor 62 to confirm that the mobile phone number is linked with a parent or guardian that is registered with a child care center. If confirmed by the other processor 62, the other processor 62 causes a confirmation code to be sent to the device 38 having the phone number via a short message service (SMS). The user may then input the confirmation code on their personal computing device which is subsequently sent to the processor 60. The processor 60 then sends the confirmation code and the phone number to the other processor 62. The processor 62 on receipt of a valid confirmation code and phone number combination provides an access token in the form of a plurality of symbols to the processor 60. The processor may subsequently use the access token to obtain details from the other processor 62 and change details on the other processor 62, the details being associated with the user, for example children registered with the child care center under the user's name, bookings, etc.

For example, the processor 60 may make the following POST request of the other processor 62, the request being for information indicative of bookings by a user between a start date and an end date:

https://app.kidsoft.com.au/api/v1/KindyNow/getBooking

The parameters of the POST request include, in this but not all examples, the API key, and the access token. The booking times (e.g. booking start time and/or booking end time) or booking identification information may be included, either of which are sufficient to determine the start time of the booking. The processor 62 may respond with, for example, symbols in JSON format, for example:
{“Bookings”: [ ],
“Status”: “OK” }

The details of the bookings would generally be located between “[” and “]”. In this example, however, there are no bookings.

The processor 60, on receiving booking request information indicative of a request for child care from a start time of a cancelled booking, generally sends to the other processor 64 via the API a make booking request indicative of the booking. The replace booking request includes the token for the user, and the start time or other information indicative of the booking start time, for example booking information that uniquely identifies the booking time. The other processor 62, on receiving the make booking request, changes the booking data.

Generally, but not necessarily, the information, received and sent by the processors 10, 60 and personal computing devices 38, 40, 42 comprise packets. The packets generally, but not necessarily, comprise, for example, a header, and a payload. The packets may also have a trailer. The packets may be structured in accordance with the Open Systems Interconnection Model or Internet Protocol Suite (IPS), in which each payload may be itself another packet of another layer of the OSI model or IPS. For example, at the physical layer the packet is a collection of bits. The physical layer packet may comprise a data link packet having a datalink header, a datalink payload and a datalink trailer. The datalink payload may in turn comprise a Network data packet such as an IP packet. The IP packet payload may comprise a TCP or UDP packet (“segment”). This layered structure may continue to the Application layer.

While the network connections described above may comprise optical and/or electrical Ethernet (for example 10 Mb, 40 Mb, 1Gb, 10Gb, 40Gb, 100Gb, 400Gb, 1Tb), it will be understood that other network types and protocols may be used, such as INFINIBAND, WiFi and cellular networks and their protocols. Generally, any packet or non packet based protocol may be used. Alternatively or additionally, one or more of the network connections may alternatively be a serial port connection, a USB port connection, a FireWire™ port connection, a ThunderBolt™ port connection, a PCI or PCIe connection, a SONET (or SDH) connection with or without a sonnet demultiplexing device, or generally any suitable type of connection.

Other forms of processor, however, may be used as suitable. For example, alternative logic devices may be used in place of the microprocessor 12. Examples of suitable alternative logic devices include application-specific integrated circuits, FPGAs, and digital signal processing units. Some of these embodiments may be entirely hardware based for further latency reduction. In another embodiment, the processor may comprise a networked plurality of computers or processors, or be a virtual machine within computer hardware. Generally, the processor may take any suitable form. The modules may be hardware modules.

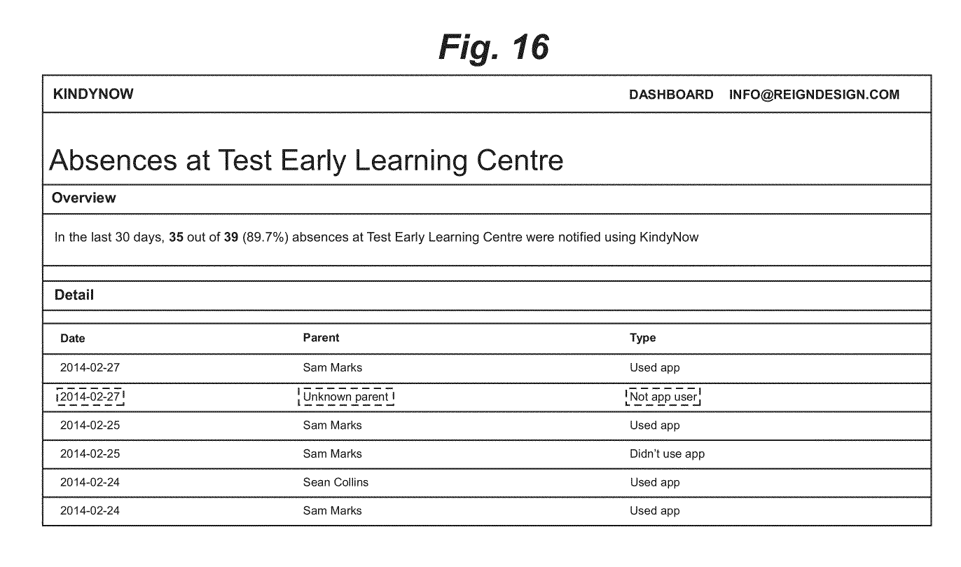

FIG. 16 shows a screen shot of the contents of a web browser window displayed by the child care center computing device 22, being a representation of information received from the processor 10, 60. The information is in the form of personal computing device usage information indicative of the usage of the plurality of personal computing devices to cancel bookings for child care. FIG. 4, for example, shows that a booking cancellation that was not requested by a personal computing device (“Didn't use app”). In some but not all embodiments, the processor 10, 60 is arranged to send a message by, for example, SMS or any other suitable channel to a user that made a booking through a channel other than the personal computing devices. The message may comprise information encouraging the user to use a personal computing device in the future.

### Service Provider's Computing Device

Child care provider's center computing device 22 is, in this but not necessarily in all embodiments, in the form of a personal computer. In this but not necessarily in all embodiments, for example, child care provider's computing device 22 has web browser software in the form of MICROSOFT INTERNET EXPLORER (although any suitable web browser may be used, further examples of which include CHROME, and FIREFOX). Operation of the web browser on the computing device 22 by the user may cause the computing device 22 to receive from the processor 10 information including current bookings for clients and/or time slots for which there is currently no booking. The received information is generally displayable by web browser on the computing device 22.

The processor 10 serves, in the example of FIG. 1, a plurality of child care center computing devices 22, 25. The processor may serve more or less than two child care center computing devices 22, 25. Generally, each computing device 22,25 is for a different child care center, however more than one child care center computing device may be for a particular child care center provider, for example one device 22 may be for management and the other 23 may be for reception.

In this but not necessarily in all examples, the child care center representative may view their own custom dashboard displayed by the computing device 22 which allows them to configure the processor 10. Configuration options include:
Offering discounts for bookings, for example, for last minute bookings which have been grouped by days out (eg. 1 day, 2-3 days and above 4 days);
Offer a discount for a user that has cancelled a booking;
Sending notifications to a user asking if their child is attending each day;

The dashboard may also display:
Penetration: The number of parents that have downloaded an App onto their personal computing device to allow them to interact with the processor 10; and
Detailed notifications: Time and parent who made the booking.

Now that embodiments have been described, it will be appreciated that some embodiments have some of the following advantages:
An available child care time may be booked with little or no input by the child care provider representative, which may otherwise be difficult to fill, especially if the available booking is in the near future, for example on the same day.
The processor may react immediately when a booking is made.
Bookings are controlled by users of child care (eg parents and guardians) rather than child care providers which previously has not been possible in the applicants best knowledge, which may be convenient for users.
The fact that users don't have to call the child care provider to make bookings during child care provider representative's time (after hours even) may reduce labour, costs and inconvenience.
Incentives may be provided that increase child care provider profitability.
Users may check for notification of available bookings, and not receive obtrusive offers by phone.
Booking may be made anywhere and anytime, especially in examples wherein the plurality of personal computing devices comprise smart phones and/or tablet computers.

Variations and/or modifications may be made to the embodiments described without departing from the spirit or ambit of the invention. For example, the network may be a local area network or a wide area network. The plurality of children may be registered at a plurality of child care centers, and notification of available child chare at any one of the plurality of child care centers may be sent to the plurality of personal computing devices associated with the plurality of children. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A method for obtaining a booking for child care starting at a time, the method comprising the steps of:
a processor sending to a plurality of personal computing devices child care availability information indicative of the availability of child care starting at the time; and
the processor receiving booking request information from one of the plurality of personal computing devices, the booking request information being indicative of a request for child care starting at the time, the processor subsequently modifying booking data stored in memory using the booking request information.

2. A method defined by claim 1 wherein the booking for child care is for a booking for child care at a child care center.

3. A method defined by claim 2 wherein the step of modifying booking data may comprise modifying child care center booking data stored in at least one of the memory and another memory using the booking request information without child care center representative input to indicate that a user of the one of the plurality of personal computing devices has booked child care at the child care center starting at the time.

4. A method defined by claim 2 wherein the step of the processor selecting the plurality of children comprises the processor selecting the plurality of children using a selection rule and the registered child data is indicative of another plurality of children registered with a provider of the child care.

5. A method defined by claim 1 wherein the step of the processor sending to the plurality of personal computing devices the child care availability information comprises the processor sending to the plurality of personal computing devices the child care availability information no earlier than a predetermined time

6. A method defined by claim 1 wherein the plurality of personal computing devices are associated with a plurality of children, and comprising the step of the processor selecting the plurality of children from registered child data stored in a memory.

7. A processor for obtaining a booking for child care starting at a time, the processor comprising at least one microprocessor, a memory and a communications interface for providing access to a communications conduit, the memory including instructions executable by the at least one microprocessor such that the processor is operable to:
send to a plurality of personal computing devices via the communications interface child care availability information indicative of the availability of child care starting at the time;
receive from one of the plurality of personal computing devices via the communications interface booking request information indicative of a request for child care starting at the time; and
modify booking data stored in at least one of the memory and another memory using the booking request information.

8. A processor defined by claim 8, wherein the booking for child care is for a booking for child care at a child care center.

9. A processor defined by claim 9 wherein modifying booking data comprises modifying child care center booking data stored in at least one of the memory and another memory using the booking request information without child care center representative input to indicate that a user of the one of the plurality of personal computing devices has booked child care at the child care center starting at the time.
